(19) United States
(12) Patent Application Publication
(10) Pub. No.: US 2003/0014445 A1
(43) Pub. Date: Jan. 16, 2003

(54) Document reflowing technique

(76) Inventors: Dave Formanek, Fort Collins, CO (US); Lynn Formanek, Fort Collins, CO (US)

Correspondence Address: Cochran & Collins LLP, Suite 230, 3555 Stanford Road, Fort Collins, CO, 80525, US

(21) Appl. No.: 09/905,628

(22) Filed: Jul. 13, 2001

(51) Int. Cl. G06F 15/00

(52) U.S. Cl. 707/526; 707/518

(57) ABSTRACT

Disclosed is a technique for generating a reflowed document image that fits the width of target display so that original electronic documents can be viewed without the necessity for tedious, horizontal scrolling. By fitting the documents to the width of the target display, the document can be read by simply scrolling in a vertical direction. The size of the text that is displayed on the target display can be varied to allow for easy reading. In addition, users having low vision can increase the size of the text to further aid in reading of the device. The target device can comprise a PDA or a large display for individuals having low vision. The reflowed electronic document is stored as a bit map image so that the original look and feel of the document can be preserved.

### BACKGROUND OF THE INVENTION

1. Field of the Invention

The present invention relates to the field of document and image understanding and processing, and more particularly to transforming document images into alternate document images that fit within a given display width and/or are scaled to various sizes.

2. Description of Related Art

Documents can be paper-based or electronic representations of information that form the basis of communication between various parties. The complexity of documents can vary greatly, from simple text documents to complex layouts including a wide variety of fonts, graphics, tables and logos.

There are many software applications for creating electronic documents. Similarly, a scanner can transform a paper document into an electronic document image. The ability to view an electronic document on a desktop computer or other device is of fundamental importance to those needing access to information.

Many electronic documents cannot easily be displayed well on devices of varying screen sizes and limited font/graphic rendering ability, especially devices such as Personal Digital Assistants (PDAs) that have limited processing and storage, as well as small screen displays (target devices). In fact, scanned documents contain no information about the layout of the various elements. Even when the screen size is sufficient to display a document at a normal resolution, visually impaired individuals may need an enlarged view of the document. If the document does not fit within the width of the screen, numerous scrolling operations must be performed in order to read each line of text in the document. In an ideal world, all documents, regardless of their electronic format, would reflow (be rearranged for better viewing on a particular screen width) and scale to any screen size desired by the person viewing the document.

Various techniques have been applied in an attempt to alleviate the problem One technique is to extract the ASCII text out of the document and reflow it for the target screen display. This often results in the loss of font information and graphic elements in the document, thus destroying the original look of the document since only the raw text (ASCII) has been extracted. For the visually impaired, techniques that allow a magnified view of the document have been implemented. This scenario requires frequent scrolling operations to read the desired part of the document. Another alternative is to republish (i.e., provide a new layout of) the document from the original electronic document software such that it displays well on a specific target device. This is a labor intensive operation and has further downside since it must be done for every possible target device. Furthermore, the target device must be capable of rendering all of the fonts/graphics in the republished document, i.e., the target must store all of the various fonts, etc. This requires a large amount of memory compared to the total memory of most PDAs.

It would therefore be desirable to make any document easily viewable on any device, by using universal format and display techniques that allow the document to retain the look of its original font and graphical elements, as well as reflow the document within the target display width. Reflowing eliminates tedious scrolling operations. Converting documents into images allows the original look of the document to be provided. Additionally, storing the structural positions of various elements in the document makes it possible to reflow and scale the document image onto target displays of varying sizes.

### SUMMARY OF THE INVENTION

The present invention overcomes the disadvantages and limitations of the prior art by providing a method for reflowing a document image based on knowledge of the positions of the various graphical elements within the document. First, each page of each document file is analyzed to determine the position of blocks of text and blocks of graphics. Next, the location of each word in each block of text is determined utilizing page decomposition software that provides a location, height and width of the bounding box for each word. The text data is reflowed, i.e. rearranged on the display screen of the target device by generating new lines of text that have a width corresponding to the total display width of the target display. This is accomplished by generating lines of text by taking each successive bounding box for each word and generating a line of text until each line is filled. If the bounding box of a word extends beyond the display width, a new line is started and the word is placed on the new line. In this fashion, each of the words is sequentially placed on lines that correspond to the width of the target display screen and, hence, are reflowed for viewing on the display screen of the target device. Scaling factors are also determined for each block of data. For standard size text, data reduction or data enhancement techniques may be used so that the text file to be displayed has a resolution that substantially matches the resolution of the display device. For non-standard size text blocks, the resolution is adjusted based upon a scaling factor related to the size of the font. In both cases, higher resolution black and white data is used to generate gray scale resolution data. For graphics blocks, data reduction techniques are used to adjust the resolution of the graphics block so that the graphics block fits within the total display width of the target device. Standard data reduction techniques can be used such as anti-aliasing, that employ averaging techniques, super sampling, or any other typical data reduction technique. Various data reduction techniques can be used for graphics depending upon the type of graphic. Data reduction techniques can also be used to display the entire page within the width of the display device. Since the present invention stores bit map image data, the original appearance of the document can be provided. The storage of bit map data also eliminates the necessity for storage of multiple font data that is required to display ASCII text in original font form. The present invention also allows the bit map data to be printed directly from the target device so that hard copies of the original documents can be generated. Compression technology can be used to compress the bit map data in accordance with standard bit map data compression techniques.

The present invention may therefore comprise a method of reflowing an electronic document file so that both text and graphics can be viewed as a reflowed document image on a target display having a predetermined target display width comprising: generating an image file of the electronic document if the electronic document does not exist as an image file; identifying text blocks and graphics blocks in the image file; identifying word locations of the text in the text blocks; generating reflowed document image positions for the word locations so that the text in the reflowed document image does not normally exceed the target display width.

The present invention may further comprise a system for reflowing an electronic document for viewing of text and graphics on a display of a target device having a predetermined width as a reflowed document image comprising: image conversion code that generates an image file of the electronic document if the electronic document does not exist as an image file; page decomposition code that identifies text blocks and graphics blocks in the image file and that identifies word locations of the text in the text blocks; and reflowing code that generates reflowed document image positions for the word locations so that the text in the reflowed document image does not normally exceed the predetermined width of the display.

The present invention may further comprise a system for reflowing an electronic document for viewing of both text and graphics as a reflowed document image comprising: a processing device that generates an image file of the electronic document if the electronic document does not exist as an image file, that identifies text blocks and graphics blocks in the image file and that identifies word locations of the text in the text blocks; and a target device coupled to the processing device so that the target device receives the image file from the processing device, the target device including a processor that generates reflowed document image positions for the word locations so that the text and graphics blocks in the reflowed document image do not normally exceed the target display width.

An advantage of the present invention is that electronic document files can be viewed on target devices such as PDAs or other portable display devices in a fashion that allows the text to be easily read without the necessity of tedious scrolling operations, especially horizontal scrolling operations. The text is scaled so that it is easily readable and appears as standard size text. Non-standard size text is scaled so that it is displayed within the width of the display device (such as with large scale text) and has a size that is sufficient to be easily readable (such as with small scale text). Also, pages can be displayed in their original page layout format. Since the present invention uses bit map data, the document appears in its original format and appearance, and can be printed as such. In addition, bit map compression techniques can be used to limit the amount of storage required in the PDA. Simple and easily executable reflowing techniques can be employed either in an upstream computing device or on the target device that requires very little computing power. When reflowing is performed in the PDA, high resolution bit maps can be downloaded to the PDA in compressed form so that high resolution documents can be printed directly from the PDA. For example, executives may desire to download portions of the Wall Street Journal or e-mail attachments in a quick, easy fashion from a computer in the office. After reviewing these documents on a PDA screen, the executive may wish to print one or more of these documents at a kiosk in the airport for further review using an infrared link between the PDA and the kiosk. The target device of the present invention may also be able to download electronic documents through RF links to an ISP or through any desired type of link to a local computer that will allow the documents to be easily stored in their original format and appearance and can be reflowed to allow the user to easily read the document without scrolling. The documents can be downloaded as images in compressed format so that they can be printed with the original resolution of the document.

Additionally, selectable scaling techniques can be used to allow users with low vision to read documents that these users would normally not be able to read without other assistance. The documents can be reflowed onto PDAs, computer screens, TVs, or any type of target display device by employing the scaling and reflowing techniques of the present invention.

### BRIEF DESCRIPTION OF THE DRAWINGS

FIG. 1a is a schematic block diagram of an implementation of the present invention.

FIG. 1b is a schematic diagram of another implementation of the present invention.

FIG. 2 is a flow diagram that provides an overall view of the steps performed in the reflowing process.

FIG. 3a is a depiction of a page of an electronic document file that includes both text and graphics in original layout and format.

FIG. 3b is a depiction of the electronic document file of FIG. 3a illustrating text blocks and graphics blocks after page decomposition techniques have been employed.

FIG. 3c is a depiction of a text block illustrating word bounding boxes.

FIG. 4 is a depiction of the manner in which both text and graphics are reflowed from an electronic document for display in a reflowed manner.

FIG. 5 is a flow diagram illustrating the details of the reflowing process.

FIG. 6 is a flow diagram illustrating steps performed in scaling of both text and graphics.

### DETAILED DESCRIPTION OF THE INVENTION

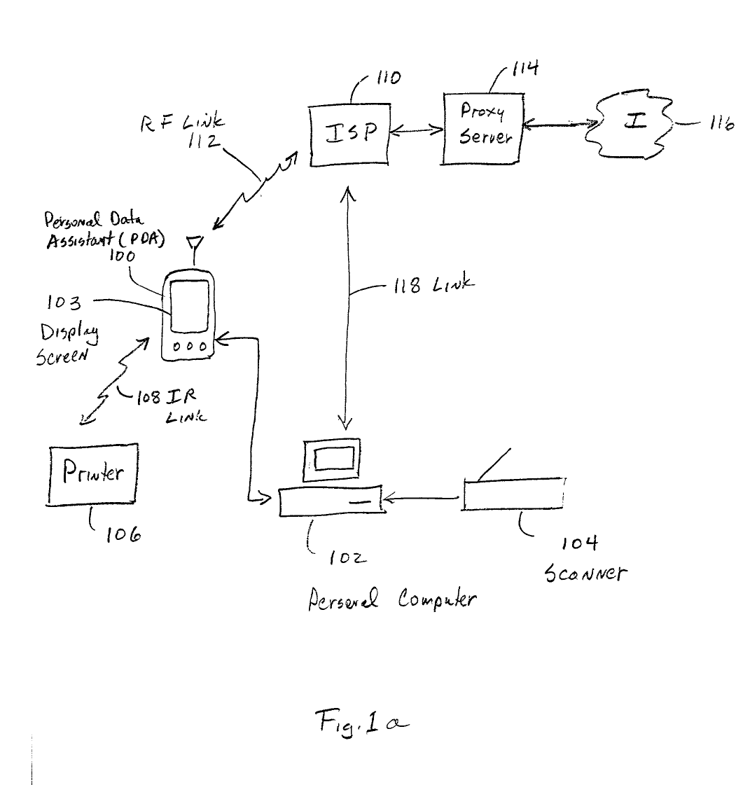

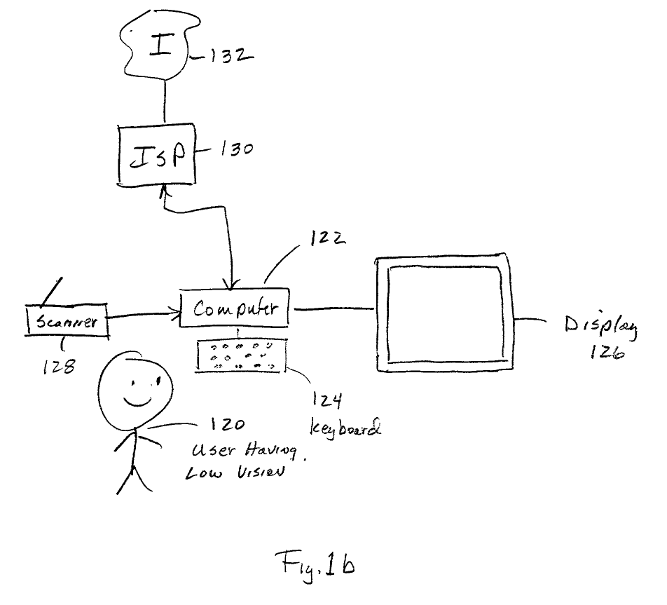

FIG. 1a discloses one implementation of the present invention using a portable personal data assistant (PDA) 100 that can be linked to a personal computer 102 or to an ISP 110. As shown in FIG. 1a, the PDA 100 may be coupled to personal computer 102 through a hard-wired connection such as a cradle, or by an RF connection, an IR connection, or any desired type of connection. The personal data assistant 100 can comprise any type of desired display device. For example, the personal data assistant (PDA) as used herein may comprise a standard PDA that includes a computer, a display, an RF link, an IR link, a cradle link, etc. The PDA may include a browser, e-mail software, and other software for processing HTML and e-mail messages, respectively. The PDA may include other devices such as a cell phone, a GPS receiver and processor, etc. In fact, the PDA may comprise any type of display device such as a display device for allowing users having low vision to view documents. In that regard, the present invention can be implemented with other types of display devices such as TV monitors, plasma screens, or other devices that can provide enlarged images. In that regard, such displays as well as those used by PDAs can be generally referred to as user display devices. Hence, a user display device may be connected to a personal computer such as personal computer 102, or to the Internet through an ISP such as ISP 110.

The PDA 100 of FIG. 1a can download electronic files from the personal computer 102 for display on the display screen 103 of the PDA 100. The personal computer may be connected to a scanner 104 that scans documents that are stored as electronic files in the personal computer 102. As explained in more detail below, the electronic documents can be stored directly from a device such as a scanner 104 as bit maps and files such as TIFF files. In addition, other types of files, such as PDF files, ASCII files, etc. can be transformed into bit maps which form the basis of the electronic files that are transferred to PDA 100 for display on display 103. Personal computer 102 may obtain electronic document files from many sources including floppy disks, network connections, and links, such as link 118 to the Internet. The PDA 100 may also be directly connected to the Internet via an RF link 112 to an ISP 110. ISP 110 is connected to a proxy server 114 which is in turn connected to the Internet 116. The proxy server 114 processes the electronic documents for transfer to the PDA 100 in the same fashion as personal computer 102. The processing performed by proxy server 114 and personal computer 102 are explained in more detail below. The PDA 100 may also have an infrared (IR) link 108 that can link the PDA 100 to various devices including printers, such as printer 106. PDA 100 may also be linked to the personal computer 102 through the IR link 108. Many variations of the system shown in FIG. 1 fall within the spirit of the present invention. In general, it is necessary that an electronic document be processed to provide the proper information to the PDA 100 so that the electronic file can be reflowed onto the display screen 103 in a reflowed manner.

Data is transferred to PDA 100 in the form of image data. The image data may be generated by the personal computer 102 or the proxy server 114. The image data may take the form of the original document image data such as 300 DPI black and white resolution data. Of course, various data compression techniques can be used to compress the image data so that the image data can be transferred and stored by the PDA 100 in a simple and easy fashion and not take excessive bandwidth or storage capabilities, respectively. Since the PDA 100 stores the high resolution image data, that data can be printed on the printer 106 so that the printed documents appear with essentially the same resolution as the original documents. Various data compression techniques exist that can be easily implemented to compress the transmitted image data. For example, character symbols can be generated based on the recognition of the images of certain characters. The character symbols can then be stored and transmitted in place of the bit map image data. Also, various other techniques can be used for compressing the image data.

FIG. 1b is a block diagram that illustrates another manner of implementing the present invention. As shown in FIG. 1b, a user 120 having a low vision operates a computer 122 having a keyboard 124. The computer 122 may be connected to the Internet 132 through an Internet service provider (ISP) 130. Alternatively, the computer 122 may be connected to other devices or peripherals such as scanner 128 that allow the computer 122 to receive electronic document files. The computer 122 performs the necessary processing of the electronic document files to place them in a bit map format and reflowed so that these documents can be displayed on a display 126. In this fashion, the user 120 having low vision can view the documents in a large reflowed format on the display 126. Hence, the user 120 is capable of scanning hard copies of documents or retrieving electronic documents from the Internet or other sources and reflowing those electronic document files in a large format so that the user 120 can read these more easily.

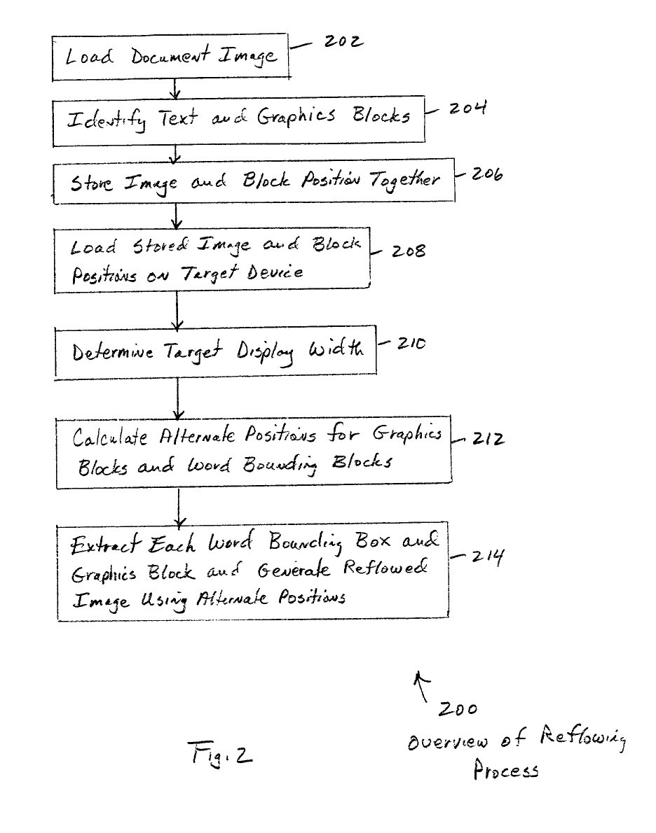

FIG. 2 is a flow chart illustrating various higher level steps that may be performed in accordance with the process of the present invention. The processing device that is performing the reflowing functions illustrated in FIG. 2 may be performed by the personal computer 102, the proxy server 114, the PDA 100, or the computer 122, or any desired processing device. At step 202, the document image is loaded. In other words, an electronic document file is loaded into the computing device. The electronic document file is first converted or rasterized into an electronic image representation such as a bit map. An electronic image (bit map) has an array of bytes which represent the individual pixels of the document. The industry standard TIFF file format is a specific instance of an electronic image format. If the document originates as a hard copy, a scanner can be used to scan the hard copy document and generate the bit map electronic document file. If the document is already an electronic format such as Adobe PDF or Microsoft Word, it can be converted into an electronic image using commonly available software such as Ghost Script or through the use of a “print to image” printer driver, respectively. Both conversion techniques are commercial available products from these respective companies. The “print to image” printer drive is available from many companies. One such company is Black Ice Software, Inc.

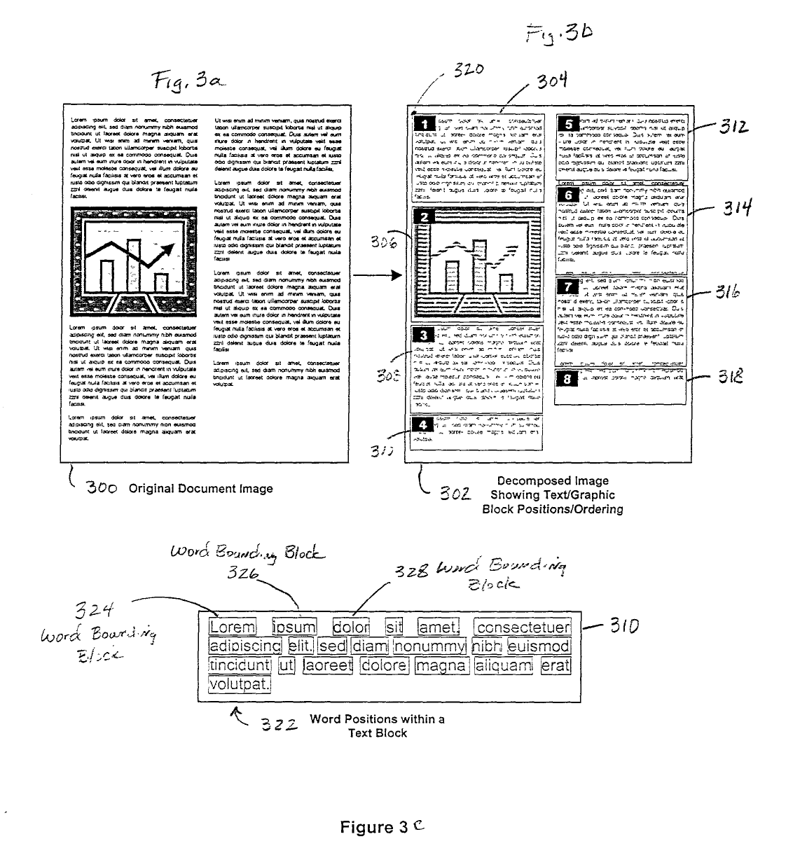

Once the electronic document is in image format as a bit map, image or page decomposition is performed to identify the block positions of various text regions and graphical elements on the electronic document page at step 204. This can be accomplished by one of the many commercially available optical character recognition toolkits such as the “Developer's Kit 2000” from Scansoft of Peabody, Mass., or the “Open RTK” toolkit from Expervision which is located in Fremont, Calif. or available at expervision.com. A more detailed explanation of the page decomposition technique is disclosed with respect of FIGS. 3a and 3b.

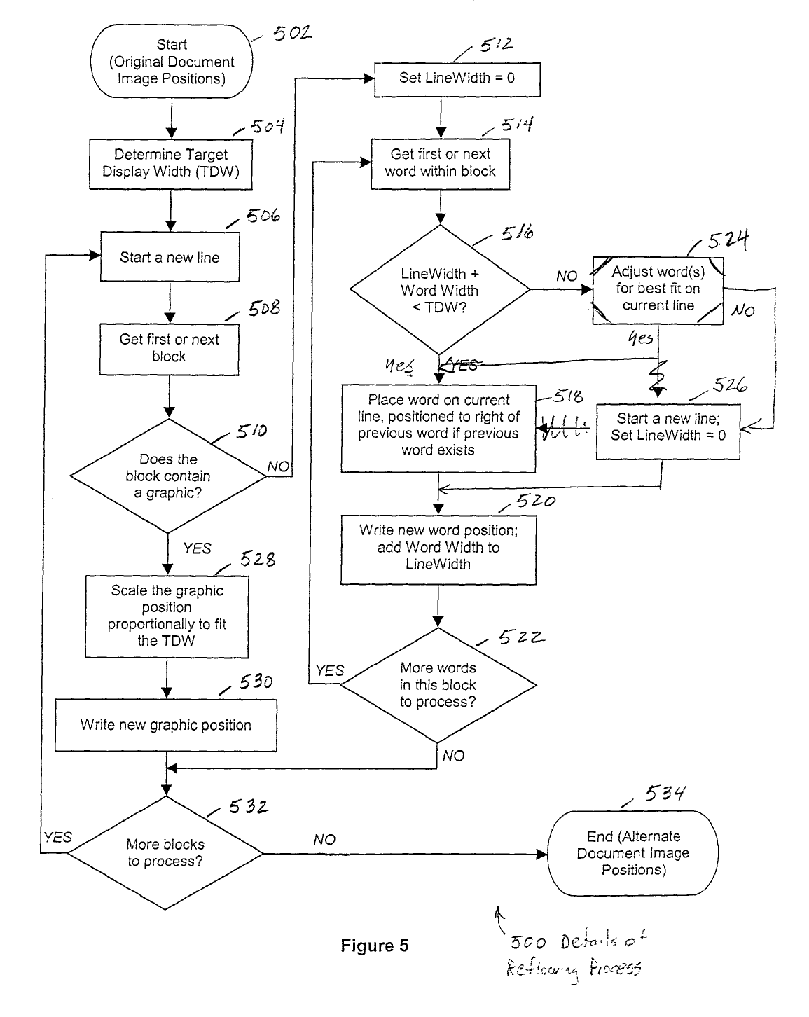

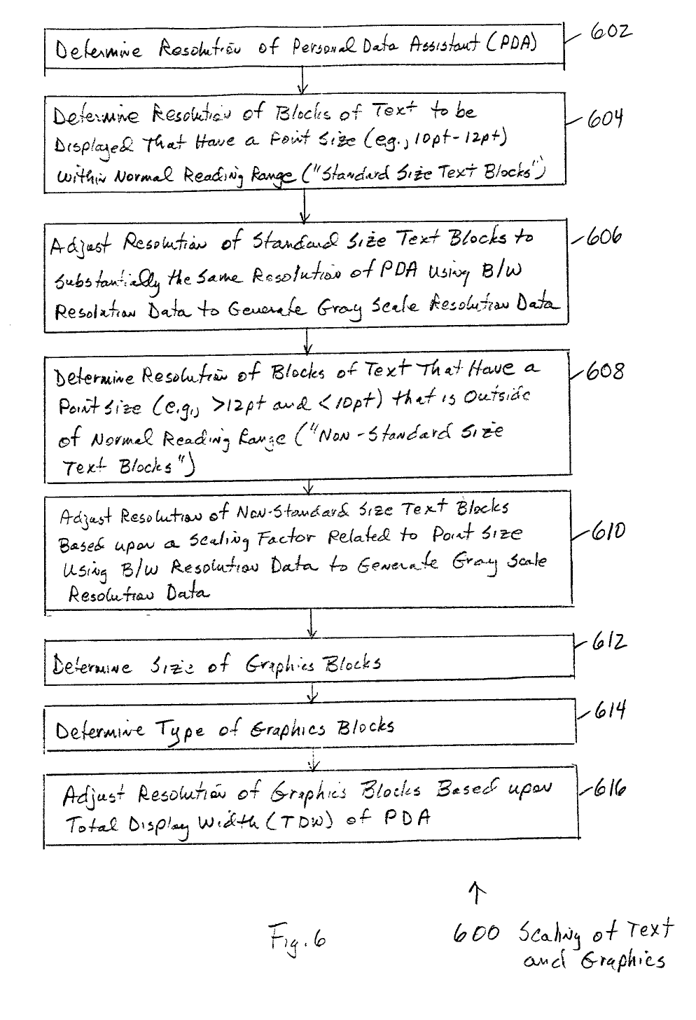

At step 206 of FIG. 2, the bit map and the text and graphic block positions are stored in the processing device. The processing device can comprise of personal computer 102, the proxy server 114 as shown in FIG. 1a, or the computer 122 of FIG. 1b. At step 208, the block positions and the bit map image are then loaded onto to the target device such as PDA 100. At step 210, the display width of the target device such as the width of the display screen 103 of PDA 100 is determined. In this instance, the reflowing software may access this information from the PDA automatically, or this information may be provided by the reflowing software that has been loaded into the PDA for the specific model of the PDA that is being used. In other words, the user of the PDA 100 must load software that performs the reflowing process of the present invention onto the PDA 100. The software loaded onto the PDA 100 must correspond to the specific model of PDA 100 that is being used. In that instance, the display width of the particular model is preloaded into the reflowing software so that the display width can be readily determined. Alternatively, the user may specify a width within which to display the document. At this time, the user may choose to display the document in the original layout format or in a reflowed manner. If the user chooses to display the document in a reflowed manner, alternate positions for graphics blocks and word bounding boxes are calculated at step 212. This process is more fully disclosed with respect to this description of FIG. 5. This process allows the document image to fit within the desired width of the display screen 103. At step 214, each of the word bounding boxes and graphics block positions is extracted for display on the target device, as is also disclosed in FIG. 5. Of course, all of the steps illustrated in FIG. 2 can be performed by the computer 122 for the implementation illustrated in FIG. 1b. Various other implementations of the present invention can be utilized, and the steps illustrated in FIG. 2 can be performed by one or more processing devices in manner similar to that described with respect to the implementation of FIG. 1a.

FIG. 3a illustrates an original document image 300 that the user may wish to display in a reflowed manner. As indicated above, the original document image may constitute an email attachment, a document downloaded from the World Wide Web, a document that has been scanned by a scanner, a fax electronic document file, or any other desired type of file including local electronic files stored on a computer such as personal computer 102 or computer 122. As indicated above, the original document image 300 comprises a bit map that may be in any desired bit map format such as TIFF. Since the electronic document 300 is a bit map, it retains all of the original layout and look and feel of the original document. In other words, the bit map image 300 appears in electronic form in a manner that shows the text portions and the original font that was used to generate the document and contains the graphic portions as bit map images. Hence, the user has the ability to view the document in its original format. This may be very important to the user. For example, the user may be an attorney who wishes to view an important letter, brief, or other legal document in its original format. Further, suppliers of the document may wish to have these documents viewed in their original format using the original fonts. For example, Wall Street Journal articles use a particular font that is particularly identifiable with the Wall Street Journal which clearly distinguishes important Wall Street Journal articles from lesser important articles, such as articles from the New York Times or the Washington Post. In other words, in many cases, it is important that the supplier of a document have that document displayed in its original font that is associated with the supplier of the document. For example, a business traveler may wish to download newspaper articles from the World Wide Web onto a PDA 100 for viewing during traveling. The reflowed documents are displayed for easy reading without extensive scrolling. Since the documents are displayed on the PDA in the original font, the reader can recognize the source of the document, such as the Wall Street Journal, even though it has been reflowed. In addition, the present invention allows an entire page of a document, such as illustrated in FIG. 3a, to be displayed full screen on the target display.

FIG. 3b illustrates a decomposed image 302 that corresponds to the document image 300 of FIG. 3a that has been decomposed into text and graphics blocks. OCR software can be used to identify various text blocks 304, 308, 310, 312, 314, 316 and 318, as well as graphics blocks 306. OCR software can also identify the location of the text and graphics blocks on the decomposed page 302. For example, text block 304 may have a location that is identified by location point 320 together with a height and width of the particular text block 304. The location of other text and graphics blocks is also provided in the same fashion. In this manner, the location of both blocks of text and blocks of graphics can be positively identified on the electronic document page 302.

FIG. 3c is a schematic illustration of 322 of the word positions within in a particular text block 310 that is illustrated in FIG. 3b. As shown in FIG. 3c, each word is surrounded by a word bounding block. For example, the first word of the text block 310 is surrounded by a word bounding block 324 that positively identifies the location of that first word on the page 302 (FIG. 3b). The word bounding block 324 can be located on the document page 302 by locating the upper left hand corner of the word bounding block and providing height and width information. Similar word bounding blocks 326 and 328 are provided for the next two words in the next block 310. Each of the words in the text block 310 is surrounded by a word bounding block that has an associated location on the page. Hence, the location of the text blocks, the graphics blocks, and each word of the electronic document is positively identified.

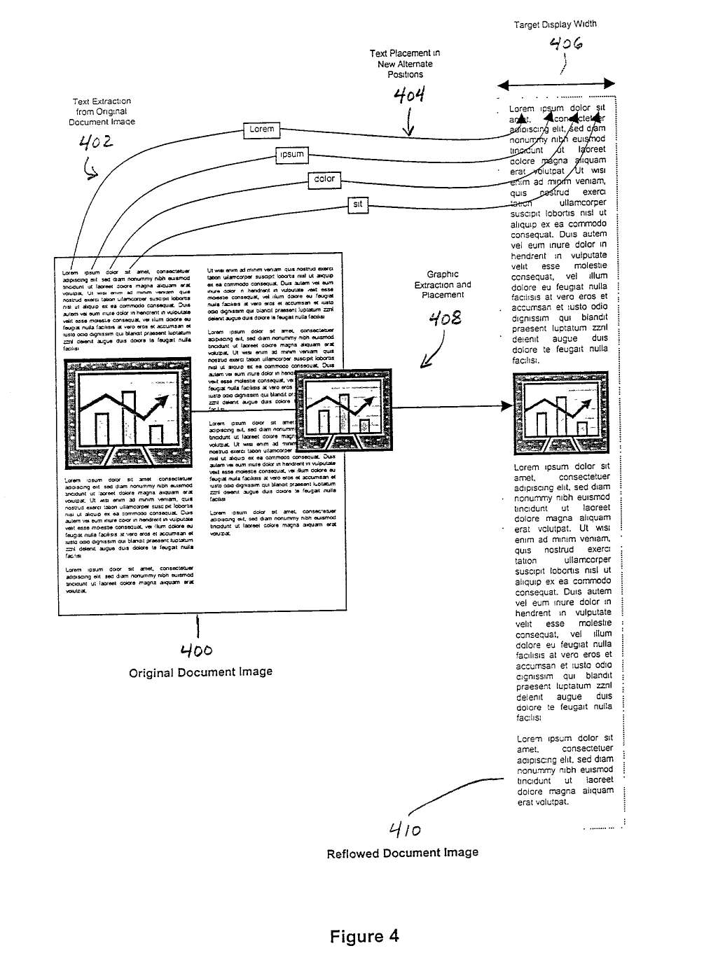

FIG. 4 is a schematic illustration of the manner in which a document can be reflowed for viewing on a target display. As shown in FIG. 4, an original document image is shown in its original layout. The original document image has text and graphics formed in two separate columns with each column having a predetermined width. The target display, however, has a different width 406 which happens to be smaller than the width of the columns of the original document image 400. In accordance with the present invention, text is extracted from the original document image as shown in step 402 on a word by word basis in the sequential order in which the words appear in the original document image 400. As shown in step 404, the text is placed in a new reflowed document in new alternate positions that fit within the target display width 406. Similarly, graphics blocks are extracted as shown in step 408 for placement within the target display width 406. This results in a reflowed document image 410 that has a width corresponding to the target display width so that the user may read the reflowed document image by merely scrolling in a vertical direction to read the document. This eliminates the need for tedious scrolling in both a horizontal and vertical direction to read documents that have not been reflowed to the width of the target display. Scaling and data reduction techniques are used to adjust the width of the graphics box.

As illustrated in FIG. 4, the target display width 406 only allows for the placement of four consecutive words from the original document image 400. The remaining words on the first line of the original document image are then placed in consecutive order on the second line of the reflowed document image in accordance with the process described with regard to FIG. 5. Scaling techniques utilizing data reduction processes can be used to adjust the size of the words in the reflowed document image 410. In addition, data enhancement techniques can be used in conjunction with scaling techniques to increase the size of the words on the reflowed document image 410 to aid users having a low vision. Scaling techniques are more fully disclosed with respect to the description of FIG. 6.

FIG. 5 is a flow diagram illustrating the detailed steps 500 of the reflowing process. The goal of the reflowing process 500 that is disclosed in FIG. 5 is to calculate new display positions for the reflowed document image 410 (FIG. 4) for each word bounding box and graphic image of the original document so that the original document may be reflowed within a given target display width (TDW) 406 (FIG. 4). The process begins by obtaining access to the image data of the original document and the position information relating to the image data of the original document, as indicated at step 502. At step 504, the target display width is determined, as indicated above, either automatically by accessing stored information or by intervention by the user. At step 506, a new output line for the reflowed document 410 is started so that the processor calculates a new vertical offset for placement of the next word bounding box. The processor then accesses the first or next block of information which may be either a text block or a graphics block, as indicated at step 508. At step 510, the processor determines whether the block contains graphics. If it does, the graphics are scaled and positioned proportionally to fit within the target display width at step 528. Scaling is more fully disclosed with respect to the description of FIG. 6. At step 530, the position of the graphic is generated in the reflowed document image 410. For example, as shown in FIG. 4, the graphic is placed within the target display width 406 in a predetermined position that has a corresponding position to the position in the original document. At step 532, it is determined whether additional blocks of graphics or text must be processed. If there are no additional blocks, the process proceeds to step 534, and the process ends. If there are more blocks to process, the process returns to step 506, and a new line position is calculated.

As also shown in FIG. 5, if it is determined at step 510 that the block of information does not contain a graphic, the process proceeds to step 512 where the variable called “line width” is first initialized to zero. At step 514, the first word or next word within the text block is retrieved. The bounding boxes for each of the words that are retrieved in sequential order from the original document add to the variable “line width”. At step 516, it is determined if the current word would cause the variable “line width” to exceed the total display width. As shown at step 516, the line width plus the word width of the current word are added together to determine if they are less than the total display width of the reflowed document image 410. If they are not less than the total display width, the words on the current line may be adjusted to best fit on that current line using enhanced processing (disclosed below) at step 524. If it is determined that the words can be adjusted to fit on the current line, the process proceeds to step 518. If it is determined that the words cannot be adjusted to fit on the current line, a new line is started at step 526, and the line width is again initialized to zero. The process then proceeds to step 520 where the position of the word is written, and the word width is added to the line width. If it is determined at 516 that the line width plus the word width is less than the total display width of the reflowed document image 410, the word is placed on the current line at step 518, positioned to the right of the previous word, if there is a previous word on that line. The process then proceeds to step 520 to write a new word position and add the word width to the line width. At step 522, it is determined whether there are more words within the text block to process. If there are more words to process, the process returns to step 514 to obtain the next word within the block. If there are no further words to process within that block of text, the process proceeds to step 534 to determine if there are more blocks to process. If there are more blocks to process, the process returns to step 506. If there are no more blocks to process, the process ends.

Enhanced processing of word bounding blocks allows more information to fit within the total display width of the reflowed document image 410. One such enhancement is the automatic removal of hyphens from words that have been split across text lines in the original document. This allows broken words to be recombined when calculating new alternate positions in the reflowed document image 410. Further, the spacing between the words and/or the dynamic scaling of individual words or white spaces between the words allows more text to fit on a single line. Large text or drop caps can also be dynamically scaled so that more text fits on a given output line. Enhanced processing can be used at step 524 in order to adjust the words to add an additional word to a particular line of text on the reflowed document image.

The new word positions and graphic block positions that are generated in accordance with the process illustrated in FIG. 5 are stored as a reflowed document image 410 for display on the target display.

FIG. 6 is a flow diagram that illustrates the steps 600 for scaling of text and graphics. As shown at step 602, the resolution of the display of the target device such as PDA 100 is determined. Resolution is normally determined in dots per inch (DPI). Some documents have black and white resolution of as much as 600 DPI, or even higher. Many documents are stored with 300 DPI black and white resolution. The size of the text characters, when printed on a document, is determined by the point size of the font. For example, a 600 DPI resolution document having a 12 point type size will provide a high resolution printout of the standard size 12 point text. If the electronic document is displayed on a 600 DPI resolution display, the text size will correspond to the printed 12 point type. However, if the 600 DPI resolution text file is displayed on a 100 DPI display, the letters will appear six times larger than they would appear on the 600 DPI resolution display. Typically, target devices such as PDAs have a lower resolution which is normally in the range of 75 to 100 DPI. Electronic text files may have varying resolution which is usually in the range of either 300 DPI or 600 DPI. Hence, scaling of the text can be accomplished by modifying the resolution of the files, in the manner disclosed in FIG. 6. In addition, text files are normally stored in a black and white format that is more suitable for printing than display. Also, electronic text documents may appear better in a gray scale format when displayed on a display device, especially when low resolution displays are being used. Hence, high resolution black and white data can be used to generate lower resolution gray scale data in accordance with the present invention.

As also shown in FIG. 6, the resolution of the blocks of text to be displayed is determined at step 604. The blocks of text, such as blocks 304, 308-318 that have a point size within the normal reading range in the decomposed image 302 (FIG. 3b), such as 10 to 12 point size type are determined. These text blocks are referred to as standard size text blocks. The resolution of the standard size text blocks is then adjusted at step 606 to substantially match the resolution of the PDA. Also, black and white resolution data may be used to generate gray scale resolution data for display. In other words, if the user desires to have the standard size text blocks appear on the target display in a reflowed manner in substantially the same size as standard 10 to 12 point text, the resolution of the electronic file can simply be reduced to match the resolution of the target display. In addition, black and white resolution data can be changed to gray scale data using standard techniques such as anti-aliasing that averages pixels to obtain a gray scale level or super sampling techniques. These constitute well-known techniques for translating black and white data to gray scale data.

However, if it is desirable to display the standard size text in either a larger or smaller size on the target display, the resolution of the reflowed document image 410 can be adjusted using the data reduction techniques or data enhancement techniques of the present invention. For example, if an electronic document file has a resolution of 600 DPI for 12 point type, and the user would like to display the document in twice its normal size, i.e. 24 point, if the resolution of the target display is 100 DPI, data reduction techniques can be used to reduce the resolution of the electronic document file to 200 DPI. In this fashion, when the text file is displayed on the target display, it will appear as the same size as 24 point type of a printed document.

As also shown in FIG. 6, the resolution of blocks of text that have a point size that is outside the normal range, i.e. greater than 12 point type or less than 10 point type, is determined. These blocks of text are considered to be non-standard size text blocks. At step 610, the resolution of the non-standard size text blocks is adjusted based upon a scaling factor related to the point size of the stored file using the black and white resolution data to generate gray scale resolution data. In other words, headers and titles may appear in a very large point text that cannot easily be displayed on the target display because of its small size. Hence, it may not be desirable to transfer a large headline for display on the target display in a large text. In other words, it may be desirable to further reduce the size of large type that may appear in headers and other places so that it can be more easily displayed on the target display. Hence, the resolution of the blocks of text that have a larger point size may be adjusted so that more of the text can be displayed on the target display in smaller size text for easier viewing on a small display screen. The same is also true for smaller point text. For example, it may be desirable to display 6 point text as 12 point text. In this fashion, the resolution can be adjusted using either data reduction or data enhancement techniques to provide the desired size text on the target display.

As also shown in FIG. 6, at step 612, the size of a graphics block is determined. At step 614, the type of graphics block may also be determined. For example, some graphics may appear as pictures while other graphics may appear as bar charts or pie charts. At step 616, the resolution of the graphics blocks is adjusted to fit the total display width of the target display. Depending on the type of graphic in the graphic box, various data reduction techniques or data enhancement techniques can be used to adjust the resolution so that the width of the graphic fits within the width of the target display.

The present invention therefore provides a unique method of reflowing electronic files so that these files can be viewed on a target display device such as a PDA or other device. The size of the displayed text can be adjusted to fit the needs of the user. For example, users having low vision can adjust the size of the text on the target display so that it can be viewed more easily. Alternatively, the size of the text can be automatically adjusted so that it appears in a normal print size, including large text or small text. The present invention stores the text files as image files in the form of a bit map so that the fonts and other graphic data appear in the same fashion as the original document. This allows the user to recognize particular articles as being from certain sources and also allows the user to view the document in its original layout and format which may be an important factor for the user and/or supplier of the electronic document file. Further, the present invention allows the entire page of the document to be displayed to allow the user to view the original page layout. Standard optical character recognition software is used to perform page decomposition techniques to identify text blocks and graphics blocks. Further, the OCR software is capable of locating the position of each word within a text block so that these words can be reflowed in order to fit the width of the target display.

Also, high resolution bit map data can be transferred directly to the target device so that the target device can print documents in a high resolution format. Additionally, data compression techniques using standard bit map data compression can be used to reduce the amount of storage required in the target device.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of reflowing an electronic document file so that both text and graphics can be viewed as a reflowed document image on a target display having a predetermined target display width comprising:
generating an image file of said electronic document if said electronic document does not exist as an image file;
identifying graphics blocks in said image file;
identifying word locations in said image file;
generating reflowed document image positions for said word locations so that said text in said reflowed document image does not normally exceed said target display width.

2. The method of claim 1 further comprising:
scaling graphics blocks that may exist in said image file so that said graphics blocks do not exceed said target display width;
generating a reflowed document image position for said graphics.

3. A method of reflowing an electronic document file so that both text and graphics can be viewed as a reflowed document image on a target display having a predetermined target display width comprising:
generating an image file of said electronic document if said electronic document does not exist as an image file;
identifying text blocks and graphics blocks in said image file;
identifying word locations of said text in said text blocks;
generating reflowed document image positions for said word locations so that said text in said reflowed document image does not normally exceed said target display width;
scaling graphics blocks that may exist in said image file so that said graphics blocks do not exceed said target display width;
generating a reflowed document image position for said graphics.

4. The method of claim 3 further comprising: scaling said text blocks so that said text appears on said target display having a predetermined size.

5. The method of claim 4 wherein scaling of said text blocks is performed by adjusting the resolution of said text blocks.

6. The method of claim 3 further comprising:
identifying text blocks having standard size text;
identifying text blocks having non-standard size text;
scaling said text blocks having standard size text using a first scaling factor;
scaling said text blocks having non-standard size text using at least one additional scaling factor.

7. The method of claim 6 wherein:
said scaling of said text blocks is performed by adjusting the resolution of said text blocks;
said scaling of said graphics blocks is performed by adjusting the resolution of said text blocks.

8. The method of claim 7 wherein adjusting the resolution of said text blocks and said graphics blocks is performed using data reduction techniques.

9. The method of claim 6 wherein said first scaling factor are selected by a user of said target device.

10. The method of claim 6 wherein said first scaling factor and said at least one additional scaling factor is selected by a user of said target device.

11. The method of claim 10 wherein said target device is a display device for users having low vision.

12. The method of claim 3 further comprising: compressing said image file using image compression techniques.

13. The method of claim 6 further comprising: compressing said image file using image compression techniques.

14. A system for reflowing an electronic document for viewing of text and graphics on a display of a target device having a predetermined width as a reflowed document image comprising:
image conversion code that generates an image file of said electronic document if said electronic document does not exist as an image file;
page decomposition code that identifies text blocks and graphics blocks in said image file and that identifies word locations of said text in said text blocks;
reflowing code that generates reflowed document image positions for said word locations so that said text in said reflowed document image does not normally exceed said predetermined width of said display.

15. The system of claim 14 further comprising:
scaling code that scales said text blocks and said graphics blocks according to scaling factors.

16. The system of claim 15 wherein said scaling factors are selected by a user of said system.

17. The system of claim 15 wherein said scaling factors are preset in said system.

18. The system of claim 14 further comprising:
a computer that executes said image conversion code, said page decomposition code and said reflowing code.

19. The system of claim 14 wherein said target device executes said reflowing code and generates said reflowed document image and further comprising:
a computer that executes said image conversion code and said page decomposition code.

20. A system for reflowing an electronic document for viewing of both text and graphics as a reflowed document image comprising:
a processing device that generates an image file of said electronic document if said electronic document does not exist as an image file, that identifies text blocks and graphics blocks in said image file and that identifies word locations of said text in said text blocks;
a target device coupled to said processing device so that said target device receives said image file from said processing device, said target device including a processor that generates reflowed document image positions for said word locations so that said text and graphics blocks in said reflowed document image do not normally exceed said target display width.
